(19) United States
(12) Patent Application Publication
(10) Pub. No.: US 2026/0077300 A1
(43) Pub. Date: Mar. 19, 2026

(54) Gas Separation Membrane, Method For Manufacturing Gas Separation Membrane, And Gas Separation Apparatus

(71) Applicant: SEIKO EPSON CORPORATION, Tokyo (JP)

(72) Inventor: Kenryu FUJISHIMA, Suwa (JP)

(21) Appl. No.: 19/332,525

(22) Filed: Sep. 18, 2025

(30) Foreign Application Priority Data
Sep. 19, 2024 (JP) 2024-161937

(51) Int. Cl. B01D 53/22; B01D 67/00; B01D 69/10; B01D 71/60

(52) U.S. Cl. CPC B01D 53/228; B01D 67/0002; B01D 67/009; B01D 69/107; B01D 71/601; B01D 2257/504

(57) ABSTRACT

Provided is a gas separation membrane including: a separation layer having a function of selecting and separating carbon dioxide; and a support layer disposed on the side opposite to the space side to which a mixed gas is supplied and containing an organopolysiloxane;
wherein when the layer thickness of the separation layer is tA [nm] and the layer thickness of the support layer is tB [nm], the separation layer and the support layer satisfy the following formulas (1) and (2), and when the separation layer is subjected to X-ray photoelectron spectroscopy to obtain an XPS spectrum and the C1s peak is subjected to waveform separation, the intensity ratio I (C—N)/I (C—C) satisfies the following formula (3).

$$1 < tA + tB < 1000 \qquad ( 1 )$$

$$0.01 < tA / tB < 0.2 0 \qquad ( 2 )$$

$$0.03 < I ( C - N ) / I ( C - C ) < 0.5 \qquad ( 3 )$$

The present application is based on, and claims priority from JP Application Serial Number 2024-161937, filed Sep. 19, 2024, the disclosure of which is hereby incorporated by reference herein in its entirety.

### BACKGROUND

### 1. Technical Field

The present disclosure relates to a gas separation membrane, a method for manufacturing a gas separation membrane, and a gas separation apparatus.

### 2. Related Art

In order to achieve carbon neutrality or carbon negativity, technologies are being considered to capture and recover carbon dioxide emitted from thermal power plants, boiler facilities, or the like, and carbon dioxide in the atmosphere. As that technique, there has been known a membrane separation method of separating carbon dioxide using a gas separation membrane.

For example, JP-A-2023-042719 discloses a gas separation membrane including a support membrane having at least a porous support layer and a crosslinked polyamide separation functional layer formed at the support membrane, wherein the separation membrane contains a substance having affinity for carbon dioxide, and the content of the affinity substance is 10% by weight to 70% by weight with respect to 100% by weight of the total weight of the separation membrane.

JP-A-2023-042719 is an example of the related art.

The gas separation membrane described in JP-A-2023-042719 is a separation membrane for concentrating and recovering carbon dioxide from a mixed gas containing carbon dioxide at a high concentration of about 50 mol %, for example. The supply pressure of the mixed gas is also as high as 3 atm. Therefore, when the carbon dioxide concentration or pressure of the supplied mixed gas is low, specifically, in cases where carbon dioxide contained in the atmosphere or in industrial exhaust gas is to be concentrated, the separation performance of the gas separation membrane cannot be sufficiently extracted.

Therefore, even in such a case, it is an object to realize a gas separation membrane that has high gas selectivity ratio and high gas permeability for carbon dioxide, while also having excellent mechanical strength.

### SUMMARY

A gas separation membrane according to an application example of the present disclosure is a gas separation membrane having a function of separating carbon dioxide from a mixed gas having a carbon dioxide concentration of more than 0 vol % and 10 vol % or less and supplied at a pressure of 0.5 atm or more and 2.0 atm or less, the gas separation membrane including:
a separation layer disposed on the space side to which the mixed gas is supplied, the separation layer including a polymer having a C—N bond and a C—C bond and having a function of selecting and separating carbon dioxide; and
a support layer disposed on the side opposite to the space side to which the mixed gas is supplied, the support layer containing an organopolysiloxane;
wherein when the layer thickness of the separation layer is tA [nm] and the layer thickness of the support layer is tB [nm], the separation layer and the support layer satisfy the following formulas (1) and (2), and
when the separation layer is subjected to X-ray photoelectron spectroscopy to obtain an XPS spectrum and the C1s peak is subjected to waveform separation,
the intensity ratio I (C—N)/I (C—C) of the peak intensity I (C—N) derived from the C—N bond to the peak intensity I (C—C) derived from the C—C bond satisfies the following formula (3).

$$1 < tA + tB < 1000 \qquad ( 1 )$$

$$0.01 < tA / tB < 0.2 0 \qquad ( 2 )$$

$$0.03 < I ( C - N ) / I ( C - C ) < 0.5 \qquad ( 3 )$$

A method for manufacturing a gas separation membrane according to an application example of the present disclosure is a method for manufacturing a gas separation membrane according to an application example of the present disclosure, and includes: bringing an amine-containing solution into contact with one surface of a membrane containing an organopolysiloxane; and
applying energy to the membrane brought into contact with the solution.

A gas separation apparatus according to an application example of the present disclosure includes:
a gas separation membrane according to an application example of the present disclosure;
a fixing portion that fixes the gas separation membrane and in which an internal space is formed at the support layer side of the gas separation membrane; and
an exhaust unit that reduces a pressure in the internal space so as to be negative with respect to an external space on the separation layer side of the gas separation membrane.

### BRIEF DESCRIPTION OF THE DRAWINGS

FIG. 1 is a cross-sectional view schematically showing a gas separation membrane according to an embodiment.

FIG. 2 is a process diagram showing a configuration of a method for manufacturing the gas separation membrane according to the embodiment.

FIG. 3 is a cross-sectional view illustrating a schematic configuration of a gas separation apparatus according to the embodiment.

FIG. 4 is Table 1 showing configurations of gas separation membranes and evaluation results of gas separation membranes in each Example and each Comparative Example.

FIG. 5 is an example of the XPS spectrum (C1s) in the vicinity of the C1s peak.

### DESCRIPTION OF EMBODIMENTS

Hereinafter, a gas separation membrane, a method for manufacturing a gas separation membrane, and a gas separation apparatus according to the present disclosure will be described in detail based on embodiments shown in the accompanying drawings.

### 1. Overview of Gas Separation Membrane

First, a configuration of a gas separation membrane according to the embodiment will be described.

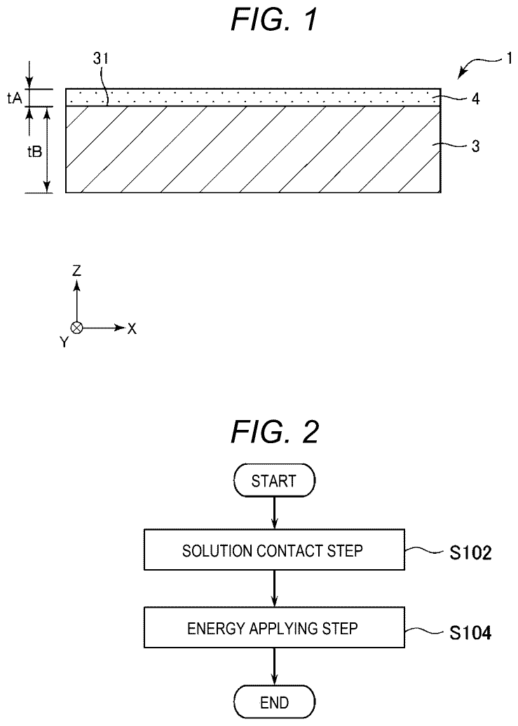

FIG. 1 is a cross-sectional view schematically showing a gas separation membrane 1 according to the embodiment. In FIG. 1 of the present application, an X axis, a Y axis, and a Z axis are set as three axes orthogonal to one another, and are indicated by arrows. A base end of the arrow indicating each axis is designated as “minus” and a tip end as “plus”.

In the gas separation membrane 1 shown in FIG. 1, a Z axis plus side is referred to as “upper”, and a Z axis minus side is referred to as “lower”. A mixed gas is supplied above the gas separation membrane 1. In the gas separation membrane 1 of FIG. 1, carbon dioxide permeates from an upper side to a lower side and is separated.

The gas separation membrane 1 shown in FIG. 1 has a function of permeating and separating carbon dioxide from a mixed gas having a carbon dioxide concentration of more than 0 vol % and 10 vol % or less and supplied at a pressure of 0.5 atm or more and 2.0 atm or less. The technique of separating carbon dioxide from the mixed gas supplied at such a relatively low carbon dioxide concentration close to atmospheric pressure is considered to be particularly highly demanded when realizing carbon neutrality or carbon negativity. For example, the atmosphere, industrial exhaust gas, and the like are representative examples of the above-described mixed gas. The gas separation membrane 1 according to the embodiment makes it possible to efficiently separate carbon dioxide from such a mixed gas.

The gas separation membrane 1 shown in FIG. 1 includes a sheet-shaped support layer 3 spreading along the X-Y plane, and a separation layer 4 provided on one surface of the support layer 3.

The separation layer 4 is disposed so as to be located on the supply side of the mixed gas. The separation layer 4 contains a polymer having a C—N bond and a C—C bond, and has a function of preferentially permeating carbon dioxide.

The support layer 3 is disposed so as to be located on the side opposite to the supply side of the mixed gas. The support layer 3 contains an organopolysiloxane.

Here, the layer thickness of the separation layer 4 is tA [nm], and the layer thickness of the support layer 3 is tB [nm]. At this time, the separation layer 4 and the support layer 3 satisfy the following formulas (1) and (2).

$$1 < tA + tB < 1000 \qquad ( 1 )$$

$$0.01 < tA / tB < 0.2 0 \qquad ( 2 )$$

In addition, when the XPS spectrum of the separation layer 4 is acquired by X-ray photoelectron spectroscopy and the C1s peak in the XPS spectrum is subjected to waveform separation, the intensity ratio I (C—N)/I (C—C) of the peak intensity I (C—N) derived from the C—N bond to the peak intensity I (C—C) derived from the C—C bond satisfies the following formula (3).

$$0.03 < I ( C - N ) / I ( C - C ) < 0.5 \qquad ( 3 )$$

According to such a configuration, it is possible to realize the gas separation membrane 1 having a high gas selectivity ratio and high gas permeability for carbon dioxide contained in the atmosphere, industrial exhaust gas, and the like and having sufficient mechanical strength.

The form of the gas separation membrane according to the present disclosure may be a sheet shape (flat plate shape) shown in FIG. 1, a spiral shape, a tubular shape, a hollow fiber shape, or the like.

### 1. 1. Support Layer

The support layer 3 has a sheet shape and supports the separation layer 4. Accordingly, even when the separation layer 4 does not have sufficient mechanical properties, the support layer 3 supports the separation layer 4, whereby the gas separation membrane 1 having sufficient mechanical characteristics can be realized.

The support layer 3 contains an organopolysiloxane. The organopolysiloxane includes, as basic constituent units, a monofunctional M unit having three organic substituents attached to a silicon atom, a bifunctional D unit having two organic substituents, and a trifunctional T unit having one organic substituent, and these units are combined to constitute the polymer. That is, the organopolysiloxane hardly contains a tetrafunctional Q unit having no organic substituent. Therefore, the organopolysiloxane has a relatively long interatomic distance of a Si—O bond and a Si—C bond constituting the organopolysiloxane, and has a large free volume, which thus allows good diffusion of carbon dioxide molecules and good gas permeability to carbon dioxide. Therefore, the support layer 3 containing the organopolysiloxane hardly inhibits gas permeability of the separation layer 4 while mechanically supporting the separation layer 4, so that the gas selectivity of the separation layer 4 can be maximized.

The constituent material of the support layer 3 may contain other materials as long as the organopolysiloxane is a main component (more than 50 mass %). Examples of other materials include polymer materials other than organopolysiloxane, ceramic materials, and metal materials.

Furthermore, the content of the organopolysiloxane in the constituent material of the support layer 3 is preferably 70 mass % or more, and more preferably 90 mass % or more.

Specific examples of the organopolysiloxane include polydimethyl siloxane, polymethylphenylsiloxane, polydiphenylsiloxane, polysulfone/polyhydroxystyrene/polydimethylsiloxane copolymer, dimethylsiloxane/methylvinylsiloxane copolymer, dimethylsiloxane/diphenylsiloxane/methylvinylsiloxane copolymer, methyl-3,3,3-trifluoropropylsiloxane/methylvinylsiloxane copolymer, dimethylsiloxane/methylphenylsiloxane/methylvinylsiloxane copolymer, diphenylsiloxane/dimethylsiloxane copolymer terminated with vinyl, polydimethylsiloxane terminated with vinyl, polydimethylsiloxane terminated with H, and dimethylsiloxane-methylhydrosiloxane copolymer. This includes a form in which a crosslinking reactant is formed. The constituent material of the support layer 3 may be one kind or a composite of two or more kinds thereof, or may be a composite material containing the organopolysiloxane as a main component (more than 50 mass %) in a mass ratio and other resin components in combination.

Among these, the organopolysiloxane contained in the support layer 3 is particularly preferably polydimethylsiloxane. Since polydimethylsiloxane contains more Si—C bonds and is chemically stable, a support layer 3 having better gas permeability of carbon dioxide and excellent stability can be obtained.

The layer thickness tB of the support layer 3 is preferably 30 nm or more and 950 nm or less, more preferably 50 nm or more and 500 nm or less, and further preferably 100 nm or more and 300 nm or less. Accordingly, the support layer 3 serves as a base layer of the gas separation membrane 1 and has necessary and sufficient mechanical characteristics.

The layer thickness tB of the support layer 3 is measured by, for example, by depth profiling of X-ray photoelectron spectroscopy for irradiating X-rays from the back surface side of the support layer 3 (the surface side opposite to the surface in contact with the separation layer 4). The depth profiling of X-ray photoelectron spectroscopy can be performed using ion beam sputtering and elemental analysis by X-ray photoelectron spectroscopy. Then, the average value of the thicknesses measured at ten locations on the support layer 3 is defined as the layer thickness tB of the support layer 3.

The gas permeability of carbon dioxide in the support layer 3 is preferably set higher than the gas permeability of carbon dioxide in the separation layer 4. Accordingly, the support layer 3 can impart good gas permeability to the gas separation membrane 1 while mechanically supporting the separation layer 4.

The gas permeability of carbon dioxide in the support layer 3 is preferably 1×10⁻⁵ cm³ (STP)/cm²·sec·cmHg (10 GPU) or more, more preferably 30 GPU or more, still more preferably 100 GPU or more, and particularly preferably 200 GPU or more.

The support layer 3 can be manufactured by a method for manufacturing a sheet or a film. In addition, the layer can also be manufactured by a method for forming a membrane on a sacrificial layer and then removing the sacrificial layer.

The support layer 3 may be a porous layer. Thus, the support layer 3 having particularly good gas permeability of carbon dioxide can be obtained.

The porous layer has the holes, and an average inner diameter thereof is referred to as an “average hole diameter”. The average hole diameter of the support layer 3 is preferably 0.2 μm or less, more preferably 0.01 μm or more and 0.15 μm or less, still more preferably 0.01 μm or more and 0.09 μm or less, and particularly preferably 0.01 μm or more and 0.07 μm or less. Accordingly, the separation layer 4 can be prevented from slipping out downstream of the support layer 3 while sufficiently ensuring the carbon dioxide gas permeability of the support layer 3. When the average hole diameter of the porous layer is less than the lower limit value, the gas permeability of carbon dioxide in the support layer 3 may decrease. Furthermore, when the average hole diameter of the porous layer exceeds the upper limit value, the separation layer 4 may slip out downstream of the support layer 3.

The average hole diameter of the porous layer can be measured by a through hole diameter evaluation device after the separation layer 4 is removed from the gas separation membrane 1 and the single support layer 3 is taken out. Examples of the through hole diameter evaluation device include a perm porometer manufactured by PMI.

A porosity of the porous layer is preferably 20% or more and 90% or less, and more preferably 30% or more and 80% or less. Accordingly, the porous layer can achieve both good gas permeability and sufficient rigidity.

The porosity of the porous layer can be measured by the above-described through hole diameter evaluation device after the separation layer 4 is removed from the gas separation membrane 1.

The support layer 3 may be a composite material of the above-described polymer material and fibers. The fiber may be used in the form of a fiber piece such as a chopped strand, but is preferably used in the form of a fabric such as a woven fabric, a non-woven fabric, or a mesh fabric. Thus, this can further enhance the mechanical characteristics of the support layer 3.

### 1.2. Separation Layer

The separation layer 4 is provided on an upper surface 31 (one surface) of the support layer 3. The separation layer 4 has gas selectivity of carbon dioxide against nitrogen.

The separation layer 4 may be a layer formed at the upper surface 31 of the support layer 3. In addition, by modifying one surface of a single membrane, the modified portion may be the separation layer 4, and the remaining portion may be the support layer 3.

The constituent material of the separation layer 4 includes a polymer having a C—N bond and a C—C bond. Among these, the C—N bond is associated with a functional group having a high affinity for carbon dioxide such as an amino group or a nitro group. Therefore, the polymer having the C—N bond contributes to the realization of the separation layer 4 having a function of selectively separating carbon dioxide.

The constituent material of the separation layer 4 may be, for example, a polymer having a molecular structure itself having a C—N bond and a C—C bond, or a material obtained by adding (modifying) at least one of a C—N bond and a C—C bond to an organopolysiloxane serving as a base polymer (polymer) afterwards. Among these, the constituent material of the separation layer 4 is preferably a material obtained by modifying the organopolysiloxane. By modifying the organopolysiloxane, the gas separation membrane 1 in which the support layer 3 and the separation layer 4 are integrated is obtained. Since such a gas separation membrane 1 is less likely to peel off at the interface, the mechanical strength is particularly good. In addition, a gas separation membrane 1 that effectively balances both gas permeability and gas selectivity can be realized by selecting and modifying an organopolysiloxane with high carbon dioxide permeability.

Examples of the polymer having a C—N bond and a C—C bond in the molecular structure itself include polyimide and epoxy resin. The epoxy resin can introduce a C—N bond into the molecular structure thereof by selecting a curing agent.

Furthermore, the organopolysiloxane serving as the base polymer contains M units, D units, and T units as the basic constituent units as described above, and the gas permeability of carbon dioxide is good. Therefore, the separation layer 4 can be manufactured by introducing a C—N bond and a C—C bond into a portion in the thickness direction of the single layer containing the organopolysiloxane serving as the raw material and modifying the portion. That is, the separation layer 4 may be a resin layer obtained by modifying a part of a single layer containing polydimethylsiloxane. According to such a configuration, it is possible to realize the gas separation membrane 1 in which the separation layer 4 having high gas selectivity for carbon dioxide, which is formed by modification, and the support layer 3 having high gas permeability for carbon dioxide, which is a portion that is not modified, are integrated.

The organopolysiloxane is a polymer containing a large number of chemical bonds such as Si—O bonds, Si—C bonds, and C—H bonds. When a part of the single layer containing the organopolysiloxane is modified as described above, first, a part of these chemical bonds can be cleaved, and another structure can be introduced into the bonding site formed by the cleavage. In this manner, a structure containing a C—N bond and a C—C bond can be introduced. Thus, the support layer 3 containing the organopolysiloxane and the separation layer 4 into which the C—N bond and the C—C bond are introduced into the organopolysiloxane are obtained.

The layer thickness tA [nm] of the separation layer 4 satisfies the relationship represented by the following formulas (1) and (2) with the layer thickness tB [nm] of the support layer 3.

$$1 < tA + tB < 1000 \qquad ( 1 )$$

$$0.01 < tA / tB < 0.2 0 \qquad ( 2 )$$

In the above formula (1), it is specified that the total tA+tB of the layer thickness tA [nm] of the separation layer 4 and the layer thickness tB [nm] of the support layer 3 is thicker than 1 nm and thinner than 1000 nm. The total layer thickness tA+tB is preferably 10 nm or more and 500 nm or less, and more preferably 50 nm or more and 300 nm or less. By satisfying such a relationship, the gas separation membrane 1 having high gas permeability of carbon dioxide and sufficient mechanical strength can be realized. When the total layer thickness tA+tB falls below the lower limit value, the mechanical strength of the gas separation membrane 1 decreases. When the total layer thickness tA+tB exceeds the upper limit value, the gas permeability of carbon dioxide in the gas separation membrane 1 decreases.

In the above formula (2), it is specified that the ratio tA/tB of the layer thickness tA [nm] of the separation layer 4 to the layer thickness tB [nm] of the support layer 3 is more than 0.01 and less than 0.20. The ratio tA/tB of the layer thickness is preferably 0.03 or more and 0.18 or less, and more preferably 0.05 or more and 0.16 or less. By satisfying such a relationship, the gas separation membrane 1 having a high gas selectivity ratio of carbon dioxide and sufficient mechanical strength can be realized. When the ratio tA/tB of the layer thickness falls below the lower limit value, the gas selectivity ratio of carbon dioxide in the gas separation membrane 1 decreases. Also, when the ratio tA/tB of the layer thickness exceeds the upper limit value, the gas permeability of carbon dioxide in the gas separation membrane 1 decreases.

The layer thickness tA of the separation layer 4 is measured by, for example, depth profiling of X-ray photoelectron spectroscopy for irradiating X-rays from the surface side of the separation layer 4 (the surface side opposite to the surface in contact with the support layer 3). The depth profiling of X-ray photoelectron spectroscopy can be performed using ion beam sputtering and elemental analysis by X-ray photoelectron spectroscopy. Then, the average value of the thicknesses measured at ten locations on the separation layer 4 is defined as the layer thickness tA of the separation layer 4.

The gas separation membrane 1 is subjected to X-ray photoelectron spectroscopy (XPS) for irradiating X-rays from the surface side of the separation layer 4. For X-ray photoelectron spectroscopy, for example, an X-ray photoelectron spectrometer, PHI X-tool manufactured by ULVAC-PHI, Inc., is used. The X-ray irradiation conditions are as follows: a beam diameter of 11 μm, an incident angle of 45°, an Al Kα radiation source, an accelerating voltage of 15 kV, and a power output of 25 W. The analysis conditions are a pass energy of 55 eV. MultiPak manufactured by ULVAC-PHI, Inc. is used as the analysis software. The waveform separation processing of the XPS spectrum by the analysis software is performed as follows.

First, the acquired XPS spectrum is loaded into analysis software, and the peak position is corrected. Next, regarding the C1s peak located between 282 and 290 eV, waveform separation is performed using a Gaussian function as the fitting function. The C—C peak, C—N peak, and C—O peak are separated as the main peaks by waveform separation. The intensity of the separated C—C peak is recorded as “peak intensity I (C—C)”. The C—C peak is usually located around 285.0 eV. The intensity of the separated C—N peak is recorded as “peak intensity I (C—N)”. The C—N peak is usually located around 285.5 to 286.0 eV. Next, the ratio of the peak intensity I (C—N) to the peak intensity I (C—C) is calculated as “intensity ratio I (C—N)/I (C—C)”.

In the separation layer 4, the intensity ratio I (C—N)/I (C—C) satisfies the relationship represented by the following formula (3).

$$0.03 < I ( C - N ) / I ( C - C ) < 0.5 \qquad ( 3 )$$

In the above formula (3), it is specified that the ratio I (C—N)/I (C—C) of the peak intensity I (C—N) to the peak intensity I (C—C) is more than 0.03 and less than 0.50. In addition, the intensity ratio I (C—N)/I (C—C) is preferably 0.05 or more and 0.30 or less, and more preferably 0.07 or more and 0.20 or less. By satisfying such a relationship, the amount of the C—N bond can be optimized with respect to the amount of the C—C bond, resulting in an improved balance between the affinity for carbon dioxide and the desorbability of carbon dioxide in the separation layer 4. In this way, the gas selectivity ratio of carbon dioxide in the gas separation membrane 1 can be increased. Moreover, when the intensity ratio I (C—N)/I (C—C) falls below the lower limit value, the affinity for carbon dioxide in the separation layer 4 decreases, so that the gas selectivity ratio of carbon dioxide in the gas separation membrane 1 decreases. When the intensity ratio I (C—N)/I (C—C) exceeds the upper limit value, the desorbability of carbon dioxide in the separation layer 4 decreases, so that the gas selectivity ratio of carbon dioxide in the gas separation membrane 1 decreases.

### 1.3. Another Configuration

Although the gas separation membrane 1 according to the embodiment is described above, any layer may be provided downstream of the support layer 3. For example, a porous plate having higher rigidity than the support layer 3 may be provided downstream of the support layer 3. The porous plate is formed with a large number of through holes so that the pressure loss of the gas passing therethrough is smaller than that of the support layer 3. Thus, the gas separation membrane 1 can be supported without inhibiting the gas selection function of carbon dioxide in the gas separation membrane 1.

Examples of the constituent material of the porous layer include a ceramic material, a metal material and a polymer material. The constituent material of the porous plate may be a composite material of these materials and other materials.

Examples of the ceramic material include alumina, cordierite, mullite, silicon carbide, and zirconia. Examples of the metal material include stainless steel.

Examples of the polymer material include polyolefin resins such as polyethylene and polypropylene, fluorine-containing resins such as polytetrafluoroethylene, polyvinyl fluoride, and polyvinylidene fluoride, polystyrene, cellulose acetate, polyurethane, polyacrylonitrile, polyphenylene oxide, polysulfone, polyethersulfone, polyimide, and polyaramid.

### 1.4. Characteristics of Gas Separation Membrane

The gas permeability R_{CO2} of carbon dioxide in the gas separation membrane 1 is preferably 200×10⁻⁶ cm³ (STP)/cm²·sec·cmHg or more (200 GPU or more), and more preferably 250 GPU or more. Accordingly, the gas separation membrane 1 having high carbon dioxide separation efficiency can be obtained. In addition, the gas separation membrane 1 that can reduce an input amount of energy required for separation, specifically, that can reduce the pressure difference between pressures upstream and downstream of the gas separation membrane 1 can be realized. The gas permeability R_{CO2} of carbon dioxide is measured by a method described later.

The gas permeability of carbon dioxide in the support layer 3 is preferably 1,000 GPU or more and 100,000 GPU or less. Within this range, it is possible to suppress the inhibition of the gas selection function of carbon dioxide in the separation layer 4. In addition, within this range, the manufacturability of the support layer 3 can be relatively enhanced.

The gas permeability of nitrogen in the gas separation membrane 1 is represented by R_{N2}, and the gas permeability of carbon dioxide is represented by R_{CO2}. At this time, the gas selectivity ratio R_{CO2}/R_{N2} of the gas separation membrane 1 is preferably 20 or more, more preferably 50 or more, and further preferably 100 or more. When the gas selectivity ratio R_{CO2}/R_{N2} is within the above range, the gas separation membrane 1 can efficiently separate and recover the carbon dioxide in the mixed gas. However, the upper limit value of the gas selectivity ratio R_{CO2}/R_{N2} may not be set, but is preferably 200 or less from the viewpoint of enhancing the manufacturability of the gas separation membrane 1.

### 2. Method for Manufacturing Gas Separation Membrane

Next, a method for manufacturing a gas separation membrane according to the embodiment will be described. In the following description, a method for manufacturing the gas separation membrane 1 shown in FIG. 1 will be described as an example.

FIG. 2 is a process diagram showing a configuration of the method for manufacturing a gas separation membrane according to the embodiment.

The method for manufacturing the gas separation membrane shown in FIG. 2 includes a solution contact step S102 and an energy applying step S104. According to such a manufacturing method, the gas separation membrane 1 can be efficiently manufactured. The steps will each be described below.

### 2.1. Solution Contact Step

In the solution contact step S102, an amine-containing solution is brought into contact with one surface of the membrane containing the organopolysiloxane. The membrane containing the organopolysiloxane is, for example, a film having a thickness corresponding to the total layer thickness of the support layer 3 and the separation layer 4 to be manufactured. By fixing such a membrane and supplying the solution so that the solution comes into contact with one surface, the organopolysiloxane exposed on one surface is brought into contact with the amine.

Examples of the amine include monoamines, polyamines, and derivatives thereof.

Examples of the monoamine include methylamine, dimethylamine, trimethylamine, ethylamine, diethylamine, and allylisopropylamine.

Examples of the polyamine include diamine and triamine. Examples of the diamine include aliphatic diamines such as ethylenediamine (EDA), propylenediamine, tetramethylenediamine (TMDA), hexamethylenediamine (HMDA), octamethylenediamine (OMDA), dodecamethylenediamine (DMDA), norbornanediamine, and 1,3-bisaminomethylcyclohexane; and aromatic diamines such as orthoxylene diamine, metaxylenediamine (MXDA), paraxylene diamine (PXDA), diaminodiphenylmethane, diaminodiphenyl ether, diaminodiphenylsulfone, and methylenebischloroaniline. Examples of the triamine include aliphatic triamines such as diethylenetriamine.

Among the amines as described above, in the present step, polyamine is preferably used, and diamine is preferably used.

The solvent of the amine-containing solution may be, for example, a solvent capable of dissolving an amine, and examples thereof include water, N, N-dimethylformamide (DMF), N-methylpyrrolidone (NMP), methanol, ethanol, isopropanol (IPA), methyl ethyl ketone (MEK), ethyl acetate, butyl acetate, toluene, acetone, cyclohexanone, hexane, and polyethylene glycol, and examples thereof include one kind or a mixture of two or more kinds thereof.

The amine concentration in the amine-containing solution is not particularly limited, but is preferably 0.1 mass % or more and 90 mass % of less, and more preferably 1 mass % or more and 50 mass % or less.

The temperature of the amine-containing solution is not particularly limited, but is preferably 10° C. or higher and 80° C. or lower, and more preferably 20° C. or higher and 60° C. or lower.

When the amine-containing solution permeates into the membrane, the layer thickness tA of the separation layer 4 can be adjusted according to the penetration depth. The penetration depth can be appropriately adjusted according to the contact time of the solution, for example.

### 2.2. Energy Applying Step

In the energy applying step S104, energy is applied to the membrane brought into contact with the amine-containing solution. When energy is applied, a part of chemical bonds such as Si—O bonds, Si—C bonds, and C—H bonds contained in the organopolysiloxane is cleaved. A part of the chemical bonds contained in the amine is also cleaved. Then, a structure derived from the amine is bonded to the binding site formed in the organopolysiloxane after cleavage. Therefore, C—N bonds and C—C bonds are introduced into the organopolysiloxane over a wide range, and the separation layer 4 can be formed.

Examples of the structure derived from an amine include an alkylamino group. The alkylamino group includes a C—N bond and a C—C bond. The number of carbon atoms of the alkylamino group is preferably 2 or more and 18 or less. The intensity ratio I (C—N)/I (C—C) can be controlled by adjusting the number of carbon atoms within this range.

Examples of the method for bringing the amine-containing solution into contact include a coating method, a spraying method, and a dipping method.

Examples of the method for applying energy include various treatments such as ultraviolet irradiation, plasma irradiation, and heating. Among these, ultraviolet irradiation treatment or plasma irradiation treatment is preferably used, and ultraviolet irradiation treatment is more preferably used.

The intensity ratio I (C—N)/I (C—C) can be controlled according to the applied energy. For example, since the energy of the C—N bond is lower than that of the C—C bond, the C—N bond tends to be more easily cleaved than the C—C bond. Therefore, the amount ratio of the C—C bond and the C—N bond can be adjusted according to the applied energy.

When ultraviolet rays or plasma is used, chemical bonds in the organopolysiloxane and chemical bonds contained in the amine can be efficiently cleaved while suppressing an increase in temperature. Therefore, the structure derived from the amine can be efficiently introduced and the membrane can be modified while suppressing the thermal denaturation of the membrane.

Examples of the ultraviolet ray generation device include an ultraviolet lamp and a light emitting diode.

The method for generating plasma is not particularly limited, but an atmospheric pressure plasma apparatus is preferably used. Further, the method for irradiating plasma is not particularly limited, but by using a method for transferring and irradiating the plasma generated at the plasma generation site (plasma jet method), deterioration of the object to be processed due to discharge or the like can be suppressed.

### 3. Use of Gas Separation Membrane

The gas separation membrane 1 according to the embodiment can be used for carbon dioxide separation and recovery from a mixed gas containing carbon dioxide, carbon dioxide separation and purification, and the like. In particular, it is effective to use the gas separation membrane 1 in a technique for separating and recovering carbon dioxide contained in the atmosphere (direct air capture (DAC)).

### 4. Gas Separation Apparatus

Next, a gas separation apparatus according to the embodiment will be described.

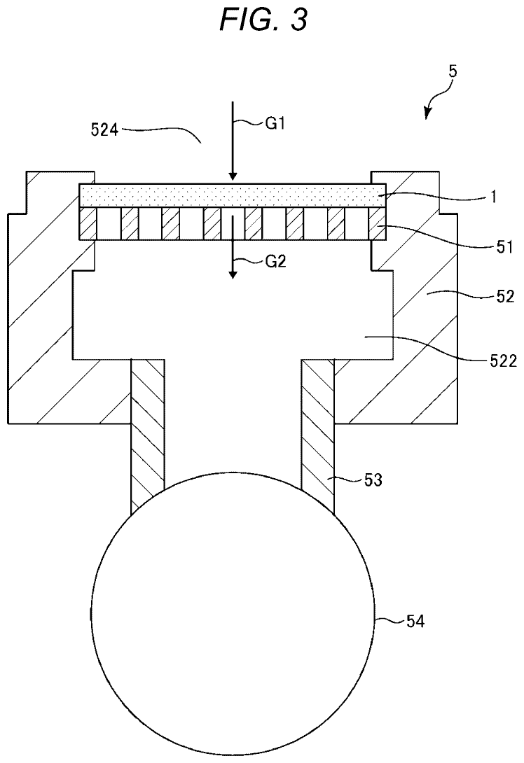

FIG. 3 is a cross-sectional view illustrating a schematic configuration of a gas separation apparatus 5 according to the embodiment.

The gas separation apparatus 5 shown in FIG. 3 includes the gas separation membrane 1, a fixing portion 52, a pipe 53, and an exhaust unit 54.

The fixing portion 52 fixes the gas separation membrane 1. The fixing portion 52 includes a porous plate 51 that supports the gas separation membrane 1. A large number of through holes are formed in the porous plate 51.

The fixing portion 52 has an internal space 522 formed therein, which is located on the support layer 3 side of the gas separation membrane 1.

The exhaust unit 54 exhausts gas in the internal space 522 via the pipe 53. Accordingly, the pressure in the internal space 522 decreases, and the pressure becomes negative with respect to an external space 524 located on the separation layer 4 side of the gas separation membrane 1.

According to such a configuration, a mixed gas G1 supplied to the external space 524 permeates through the gas separation membrane 1, and a permeate gas G2 can be recovered. The mixed gas G1 is a mixed gas having a carbon dioxide concentration of more than 0 vol % and 10 vol % or less and supplied at a pressure of 0.5 atm or more and 2.0 atm or less. The carbon dioxide concentration of the permeate gas G2 is higher than that of the mixed gas G1. Accordingly, carbon dioxide can be separated and recovered from the mixed gas G1.

In addition, the gas separation membrane 1 has a high gas selectivity ratio and high gas permeability for carbon dioxide contained in the atmosphere, industrial exhaust gas, or the like, and has sufficient mechanical strength. Therefore, the gas separation apparatus 5 having excellent carbon dioxide separation performance can be realized.

### 4. Effects of Embodiment

The gas separation membrane 1 according to the embodiment has a function of separating carbon dioxide from a mixed gas having a carbon dioxide concentration of more than 0 vol % and 10 vol % or less and supplied at a pressure of 0.5 atm or more and 2.0 atm or less. The gas separation membrane 1 includes the separation layer 4 and the support layer 3. The separation layer 4 is disposed on the space side to which the mixed gas is supplied, contains a polymer having a C—N bond and a C—C bond, and has a function of selecting and separating carbon dioxide. The support layer 3 is disposed on the side opposite to the space to which the mixed gas is supplied, and contains an organopolysiloxane. When the layer thickness of the separation layer 4 is tA [nm] and the layer thickness of the support layer 3 is tB [nm], the separation layer 4 and the support layer 3 satisfy the following formulas (1) and (2), and when the XPS spectrum of the separation layer 4 is acquired by X-ray photoelectron spectroscopy and the C1s peak is subjected to waveform separation, the intensity ratio I (C—N)/I (C—C) of the peak intensity I (C—N) derived from the C—N bond to the peak intensity I (C—C) derived from the C—C bond satisfies the following formula (3).

$$1 < tA + tB < 1000 \qquad ( 1 )$$

$$0.01 < tA / tB < 0.2 0 \qquad ( 2 )$$

$$0.03 < I ( C - N ) / I ( C - C ) < 0.5 \qquad ( 3 )$$

According to such a configuration, it is possible to realize the gas separation membrane 1 having a high gas selectivity ratio and high gas permeability for carbon dioxide contained in the atmosphere, industrial exhaust gas, and the like and having sufficient mechanical strength.

In the gas separation membrane 1 according to the embodiment, the separation layer 4 may be a resin layer that is modified by introducing a C—N bond and a C—C bond into a part of the membrane containing the organopolysiloxane in the thickness direction.

According to such a configuration, the gas separation membrane 1 in which the support layer 3 and the separation layer 4 are integrated is obtained. Since such a gas separation membrane 1 is less likely to peel off at the interface, the mechanical strength is particularly good. In addition, a gas separation membrane 1 that effectively balances both gas permeability and gas selectivity can be realized by selecting and modifying an organopolysiloxane with high carbon dioxide permeability.

In the gas separation membrane 1 according to the embodiment, when the gas permeability of nitrogen is represented by R_{N2} and the gas permeability of carbon dioxide is represented by R_{CO2}, the gas selectivity ratio R_{CO2}/R_{N2} is preferably 20 or more, and the gas permeability of carbon dioxide R_{CO2} is preferably 200 GPU or more.

According to such a configuration, the gas separation membrane 1 having high carbon dioxide separation efficiency can be realized. In addition, the amount of energy required for separation can be reduced.

In the gas separation membrane 1 according to the embodiment, the organopolysiloxane contained in the support layer 3 may be polydimethylsiloxane.

According to such a configuration, since polydimethylsiloxane contains more Si—C bonds and is chemically stable, a support layer 3 having better gas permeability of carbon dioxide and excellent stability can be obtained.

The method for manufacturing a gas separation membrane according to the embodiment is a method for manufacturing the gas separation membrane 1 according to the embodiment, and includes the solution contact step S102 and the energy applying step S104. In the solution contact step S102, an amine-containing solution is brought into contact with one surface of the membrane containing the organopolysiloxane. In the energy applying step S104, energy is applied to the membrane brought into contact with the amine-containing solution.

According to such a configuration, it is possible to efficiently manufacture the gas separation membrane 1 a having high gas selectivity ratio and high gas permeability for carbon dioxide contained in the atmosphere, industrial exhaust gas, and the like and having sufficient mechanical strength.

In the method for manufacturing the gas separation membrane according to the embodiment, the step of applying energy may include a treatment of irradiating the membrane with ultraviolet rays.

According to such a configuration, chemical bonds in the organopolysiloxane and chemical bonds contained in the amine can be efficiently cleaved while suppressing an increase in temperature. Therefore, the structure derived from the amine can be efficiently introduced and the membrane can be modified while suppressing the thermal denaturation of the membrane.

The gas separation apparatus 5 according to the embodiment includes the gas separation membrane 1 according to the embodiment, the fixing portion 52, and the exhaust unit 54. The fixing portion 52 fixes the gas separation membrane 1. The fixing portion 52 has the internal space 522 formed at the support layer 3 side of the gas separation membrane 1. The exhaust unit 54 reduces the pressure in the internal space 522 so as to be negative with respect to the external space 524 on the separation layer 4 side of the gas separation membrane 1.

According to such a configuration, the gas separation apparatus 5 having excellent carbon dioxide separation performance can be realized.

The gas separation membrane, the method for manufacturing the gas separation membrane and the gas separation apparatus according to the present disclosure have been described above based on the preferred embodiment, but the present disclosure is not limited thereto.

For example, the gas separation membrane and the gas separation apparatus according to the present disclosure may be a configuration in which each unit of the above-described embodiment is replaced with a constituent having substantially the same function, or may be an configuration in which any constituents are added to the above-described embodiment.

The method for manufacturing the gas separation membrane according to the present disclosure may be one in which any desired process is added to the above embodiment.

### EXAMPLES

Next, specific examples of the present disclosure will be described.

### 5. Preparation of Gas Separation Membrane

### 5.1. Example 1

First, a PDMS sheet was prepared. The PDMS sheet is a 30 μm thick sheet made of unsubstituted polydimethyl siloxane. Next, an ethylenediamine aqueous solution was applied to one surface of the PDMS sheet. Next, the one surface of the PDMS sheet was irradiated with ultraviolet ray at a wavelength of 365 nm for 1 hour. Thus, an alkylamino group was introduced into the one surface of the PDMS sheet to obtain a gas separation membrane.

### 5.2. Examples 2 to 6 and Comparative Examples 1 to 6

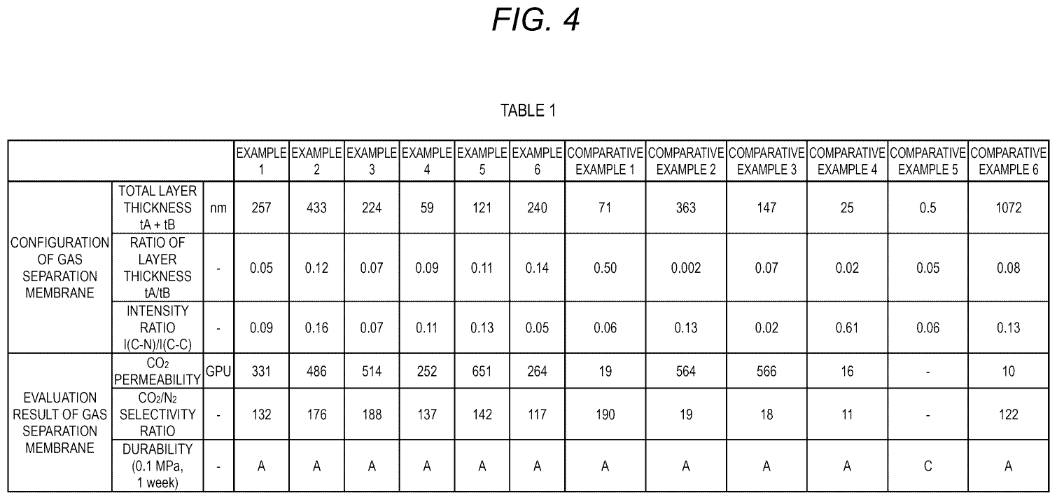

A gas separation membrane was obtained in the same manner as in Example 1 except that a configuration of the gas separation membrane was changed as shown in Table 1 (FIG. 4).

FIG. 4 is Table 1 showing configurations of gas separation membranes and evaluation results of gas separation membranes in each Example and each Comparative Example.

### 6. Measurement of Layer Thickness of Gas Separation Membrane

The layer thicknesses of the support layers and the separation layers of the gas separation membranes in each Example and each Comparative Example were measured by depth profiling using X-ray photoelectron spectroscopy. Next, based on the measurement results, the total tA+tB of the layer thickness tA [nm] of the separation layer and the layer thickness tB [nm] of the support layer, and the ratio tA/tB of the layer thickness tA [nm] of the separation layer to the layer thickness tB [nm] of the support layer were calculated. The calculation results are shown in Table 1 (FIG. 4).

### 6. X-Ray Photoelectron Spectroscopy for Gas Separation Membrane

The gas separation membranes in each Example and each Comparative Example were subjected to X-ray photoelectron spectroscopy to obtain XPS spectra. Then, the XPS spectrum was subjected to waveform separation processing by analysis software to obtain peak intensity I (C—C) and peak intensity I (C—N). In addition, the intensity ratio I (C—N)/I (C—C) was calculated. The calculated intensity ratios I (C—N)/I (C—C) are shown in Table 1 (FIG. 4).

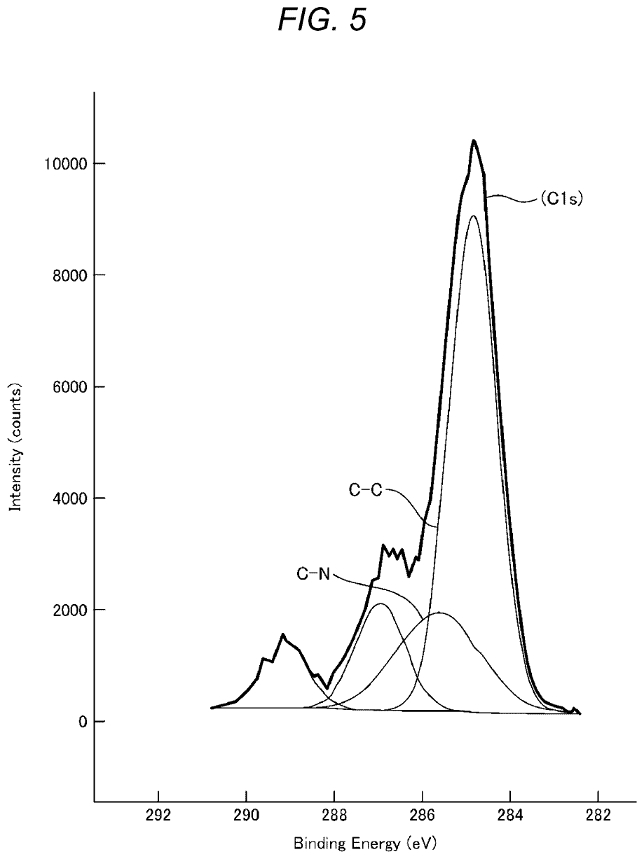

FIG. 5 is an example of the XPS spectrum (C1s) near the C1s peak. FIG. 5 also illustrates the C—C peak and the C—N peak separated by the waveform separation process.

### 7. Evaluation of Gas Separation Membrane

The gas separation membranes in each Example and each Comparative Example were evaluated as follows.

### 7.1. Gas Permeability (CO₂ Permeability)

The gas separation membranes in each Example and each Comparative Example were cut into a circle having a diameter of 5 cm to prepare test samples. Next, using a gas permeability measuring apparatus, a mixed gas obtained by mixing carbon dioxide:nitrogen at a volume ratio of 5:95 was supplied upstream of the test sample. At this time, a total upstream pressure was adjusted to 1.2 atm, a flow rate of the mixed gas was adjusted to 500 mL/min, and a temperature was adjusted to 40° C. The gas permeability was measured according to a gas permeability test method (Part 1: differential pressure method) specified in JIS K 7126-1:2006. As the gas permeability measuring apparatus, GTR-11A/31A manufactured by GTR TEC Corporation was used. In the apparatus, gas that permeated the test sample is introduced into a gas chromatograph, and the gas permeability of each component is measured.

Next, the CO₂ permeability in each gas separation membrane was calculated based on the analysis result. The calculation results are shown in Table 1 (FIG. 4).

7.2. Gas Selectivity (CO₂/N₂ Selectivity Ratio)

Based on the above-described analysis results, the N₂ permeability in the gas separation membrane was calculated. Subsequently, the ratio of the CO₂ gas permeability to the N₂ gas permeability was calculated as the CO₂/N₂ gas selectivity ratio. The calculation results are shown in Table 1 (FIG. 4).

### 7.3. Gas Strength (Durability)

The gas separation membranes in each Example and each Comparative Example were set in a gas permeability measuring apparatus, and the pressure downstream was reduced so that the pressure difference (differential pressure) between the upstream and downstream was 0.1 MPa. Then, this state was maintained for one week.

After one week, the gas separation membrane was taken out and observed under magnification to check for any damage. Then, observation results were evaluated in view of the following evaluation criteria. Evaluation results are shown in Table 1.
A: No damage was observed in the gas separation membrane.
C: Breakage was observed in the gas separation membrane.

As is clear from Table 1, it was confirmed that the gas separation membranes in each Example had a high gas selectivity ratio and high gas permeability for carbon dioxide and had excellent mechanical strength.

What is claimed is:

1. A gas separation membrane having a function of separating carbon dioxide from a mixed gas having a carbon dioxide concentration of more than 0 vol % and 10 vol % or less and supplied at a pressure of 0.5 atm or more and 2.0 atm or less, the gas separation membrane comprising:
a separation layer disposed on the space side to which the mixed gas is supplied, the separation layer comprising a polymer having a C—N bond and a C—C bond and having a function of selecting and separating carbon dioxide; and
a support layer disposed on the side opposite to the space side to which the mixed gas is supplied, the support layer containing an organopolysiloxane;
wherein when the layer thickness of the separation layer is tA [nm] and the layer thickness of the support layer is tB [nm], the separation layer and the support layer satisfy the following formulas (1) and (2), and
when the separation layer is subjected to X-ray photoelectron spectroscopy to obtain an XPS spectrum and the C1s peak is subjected to waveform separation,
the intensity ratio I (C—N)/I (C—C) of the peak intensity I (C—N) derived from the C—N bond to the peak intensity I (C—C) derived from the C—C bond satisfies the following formula (3).
$$1 < tA + tB < 1000 \qquad ( 1 )$$
$$0.01 < tA / tB < 0.2 0 \qquad ( 2 )$$
$$0.03 < I ( C - N ) / I ( C - C ) < 0.5 \qquad ( 3 )$$

2. The gas separation membrane according to claim 1, wherein the separation layer is a resin layer that is modified by introducing the C—N bond and the C—C bond into a part of the membrane containing the organopolysiloxane in the thickness direction.

3. The gas separation membrane according to claim 1, wherein when the gas permeability of nitrogen is represented by R_{N2} and the gas permeability of carbon dioxide is represented by R_{CO2}, the gas selectivity ratio R_{CO2}/R_{N2} is 20 or more, and
the gas permeability of carbon dioxide R_{CO2} is 200 GPU or more.

4. The gas separation membrane according to claim 1, wherein the organopolysiloxane contained in the support layer is polydimethylsiloxane.

5. A method for manufacturing the gas separation membrane according to claim 1, comprising;
bringing an amine-containing solution into contact with one surface of the membrane containing the organopolysiloxane; and
applying energy to the membrane brought into contact with the solution.

6. The method for manufacturing the gas separation membrane according to claim 5, wherein the applying energy comprises a treatment of irradiating the membrane with ultraviolet rays.

7. A gas separation apparatus comprising:
the gas separation membrane according to claim 1;
a fixing portion that fixes the gas separation membrane and in which an internal space is formed at a support layer side of the gas separation membrane; and
an exhaust unit that reduces a pressure in the internal space so as to be negative with respect to an external space on a separation layer side of the gas separation membrane.
